(19) United States
(12) Patent Application Publication
(10) Pub. No.: US 2012/0246401 A1
(43) Pub. Date: Sep. 27, 2012

(54) IN-MEMORY PROCESSOR

(75) Inventors: Oren Agam, Zichron Yaakov (IL); Moshe Meyassed, Kadima (IL); Yukio Fukuzo, Hachiouji (JP)

(73) Assignee: ZIKBIT LTD., Tel Aviv, IL (IL)

(21) Appl. No.: 13/502,783

(22) PCT Filed: Oct. 21, 2010
(86) PCT No.: PCT/IB10/54780

§ 371 Date: Jun. 19, 2012

Related U.S. Application Data
(60) Provisional application No. 61/253,563, filed on Oct. 21, 2009.

(51) Int. Cl. G06F 12/00

(52) U.S. Cl. 711/105; 711/167; 711/E12.001

(57) ABSTRACT

A memory device includes at least two memory banks storing data and an internal processor. The at least two memory banks are accessible by a host processor. The internal processor receives a timeslot from the host processor and processes a portion of the data from an indicated one of the at least two banks of the memory array during the timeslot while the remaining banks are available to the host processor during the timeslot. A method of operating a memory device having banks storing data includes a host processor issuing per bank timeslots to an internal processor of a memory device, the internal processor operating on an indicated bank of the memory device during the timeslot and the host processor not accessing the indicated bank during the timeslot.

### CROSS-REFERENCE TO RELATED APPLICATIONS

This application claims benefit from U.S. Provisional Patent Application No. 61/253,563, filed Oct. 21, 2009, which is hereby incorporated in its entirety by reference.

### FIELD OF THE INVENTION

The present invention relates to memory cells generally and to their use for computation in particular.

### BACKGROUND OF THE INVENTION

Memory arrays, which store large amounts of data, are known in the art. Over the years, manufacturers and designers have worked to make the arrays physically smaller and the amount of data stored therein larger.

Computing devices typically have one or more memory array to store data and a central processing unit (CPU) and other hardware to process the data. The CPU is typically connected to the memory array via a bus. Unfortunately, while CPU speeds have increased tremendously in recent years, the bus speeds have not increased at an equal pace. Accordingly, the bus connection acts as a bottleneck to increased speed of operation.

US Patent Publication 2009/0303767, assigned to the common assignee of the present invention, describes a memory array in which processing happens within the array. Separate processing areas are located between sections of the array. This is more efficient because there is no need to bring the data out of the array, to process it and then to bring it back into the array for storage. The architecture enables generally simultaneous access to different parts of the memory array by both an external device and the internal processing elements.

### SUMMARY OF THE INVENTION

There is provided, in accordance with a preferred embodiment of the present invention, a memory device including at least two memory banks storing data and an internal processor. The at least two memory banks are accessible by a host processor and the internal processor receives a timeslot from the host processor and processes a portion of the data from an indicated one of the at least two banks of the memory array during the timeslot. The remaining the banks are available to the host processor during the timeslot.

Moreover, in accordance with a preferred embodiment of the present invention, the internal processor includes an internal activator to activate the portion independent of activation of the remaining banks by the host processor during the timeslot.

Further, in accordance with a preferred embodiment of the present invention, the internal activator includes an internal processing controller and a column address burst element. The internal processing controller provides an internal address to column and row address buffers of the memory device upon receipt of the timeslot command and the column address burst element provides address bursts to activated columns of the memory bank for the duration of the timeslot.

Still further, in accordance with a preferred embodiment of the present invention, the memory device also includes a command decoder to provide a timeslot command to the internal processor and to provide other commands to a general controller of the memory device.

Additionally, in accordance with a preferred embodiment of the present invention, the memory array is a DRAM array.

There is also provided, in accordance with a preferred embodiment of the present invention, a method of operating a memory device having banks storing data. The method includes a host processor issuing per bank timeslots to an internal processor of a memory device, the internal processor operating on an indicated bank of the memory device during the timeslot and the host processor not accessing the indicated bank during the timeslot.

Moreover, in accordance with a preferred embodiment of the present invention, the operating includes activating a row in an indicated bank of the memory device during a timeslot provided by the host processor, transferring data from the row to an internal processor and precharging the row.

Finally, there is also provided, in accordance with a preferred embodiment of the present invention, a further method of operating a memory device. The method includes a host processor issuing input and output commands to memory banks of the memory device and the host processor issuing a start processing command to an internal processor connected to the memory banks to start operating on an indicated one of the memory banks, the indicated bank not receiving either of the input and output commands for the duration of the start processing command.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a memory array with in-memory processing, constructed and operative in accordance with a preferred embodiment of the present invention;

FIG. 2 is a flow chart illustration of a part of the operation of the memory array of FIG. of FIG. 1;

FIG. 3 is a timing diagram of the operation of the memory array of FIG. 1; and

FIG. 4 is a detailed illustration of the elements of the memory array of FIG. 1.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicants have realized that there may be contentions if the internal processor accesses a bank of the memory array without the host processor knowing about it.

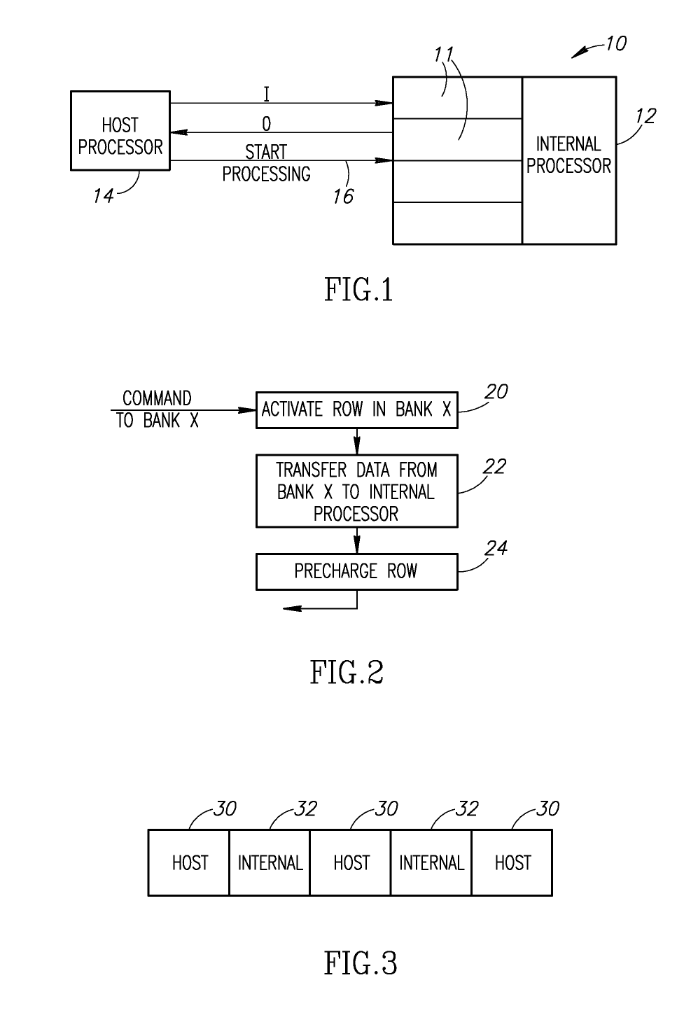

Reference is now made to FIG. 1, which schematically illustrates a memory array 10 with in-memory processing, constructed and operative in accordance with a preferred embodiment of the present invention. Memory array 10 may have a plurality of banks 11 and a centrally located internal processor 12 and may be accessed by an external device, such as a host processor 14. Host processor 14 may access memory array 10 to retrieve data stored therein and/or to store data therein. These are standard input/output (I/O) operations on memory array 10.

In accordance with a preferred embodiment of the present invention and as indicated by command arrow 16, host processor 14 may also command internal processor 12 to start processing. Such a command 16 may take any form and may indicate at least the bank 11 to be accessed for the internal processing.

For example, memory array 10 may be based on a DRAM array. Standard DRAM arrays have an ACT command, with which the host processor indicates to the array to read a particular address. In accordance with a preferred embodiment of the present invention, memory array 10 may also have an “MACT” command which may operate similarly to the ACT command. However, the parameter to the MACT command may be a bank number. In response to the MACT command, internal processor 12 may generate the row address within the indicated bank 11.

As shown in FIG. 2, to which reference is now briefly made, when an MACT command to bank X is received, internal processor 12 may supply (step 20) a row address of a row in the bank 11 to be activated and data may be transferred (step 22) between the selected bank of memory array 10 and internal processor 12. Finally, the accessed row may be automatically precharged (step 24), preparing bank 11 for another access, either by internal processor 12 or by host processor 14.

While internal processor 12 may be processing the data of a first MACT command, host processor 14 may issue another MACT command or an ACT command to other banks. It is possible that host processor 14 may access other banks while internal processor 12 processes data from the bank indicated in the first MACT command.

In accordance with a preferred embodiment of the present invention, in order for internal processor 12 to access a particular bank 11, host processor 14 must issue an MACT command for that bank. Thus, host processor 14 may issue MACT commands to each bank 11 periodically.

Applicants have realized that, by issuing MACT commands regularly to different banks 11, host processor 14, in effect, may be allocating timeslots to internal processor 12. This is shown in FIG. 3, to which reference is now briefly made. During timeslots 30, host processor 14 may control the input/output activity of the entire memory array 10 while for timeslots 32, host processor 14 may issue a MACT command, enabling internal processor 12 to operate on a particular bank. Typically, the MACT command may last a predefined number of cycles, such as 32 cycles, or a predefined length of time, such as 200 ns. It will be appreciated that, during the MACT command, host processor 14 may access any of the other banks of memory array 10 not indicated in the particular MACT command.

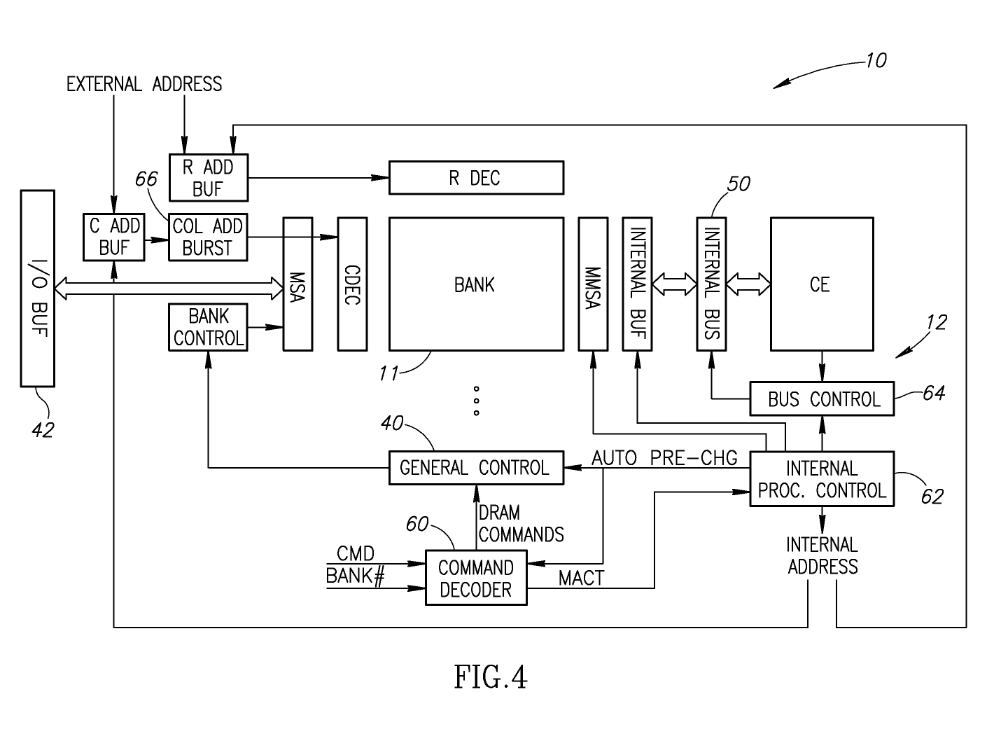

Reference is now made to FIG. 4, which is a block diagram illustration of memory array 10, constructed and operative in accordance with a preferred embodiment of the present invention. FIG. 4 shows only 1 bank and its associated elements; it will be appreciated that this is for simplification only. A typical memory might have 4 or more banks.

Memory array 10 may comprise at least some of the standard elements of a DRAM array. For example, for each bank 11, memory array 10 may comprise a row decoder RDEC, a column decoder CDEC, a main sense amplifier MSA, a row address buffer RAddBuf, a column address buffer CaddBuf and a bank controller BankCtrl. For overall operation, there may be a general controller 40, which may instruct the individual bank controller BankCtrl, and an I/O bus 42, which may provide input to and receive output from main sense amplifier MSA.

General controller 40 may indicate to bank controller BankCtrl the operation to perform, be it a read, a write, a precharge, etc. In regular operation, host processor 14 (FIG. 1) may provide row and column addresses (shown in FIG. 4 as external addresses) to row address buffer RaddBuf and column address buffer CaddBuf, respectively, to access a desired storage element or set of storage elements. The buffers may provide the buffered addresses to row decoder RDEC and column decoder CDEC, respectively, at the appropriate time. Main sense amplifier MSA may read the data from bank 11 providing the output to I/O bus 42. Alternatively, I/O bus 42 may provide the data to be written to main sense amplifier MSA which may write the data to the activated storage element(s) of bank 11.

As discussed in PCT Patent Application PCT/IB2010/054526, filed on Oct. 6, 2010, assigned to the common assignee of the present invention and incorporated herein by reference, memory array 10 may also comprise internal processor 12, comprised of internal processing elements, such as a mirror main sense amplifier MMSA and an internal buffer IntBuf per bank 11, an internal bus 50 and at least one compute engine CE. Mirror main sense amplifier MMSA may operate similarly to main sense amplifier MSA but may provide its data to and from internal bus 50. Internal bus 50 may, in turn, provide its data to compute engine CE.

In accordance with a preferred embodiment of the present invention, memory array 10 may also comprise a command decoder 60, an internal processing controller 62 and a bus controller 64 and per bank, column address burst elements 66. Command decoder 60 may receive the commands from host processor 14 and may separate the commands, providing the DRAM commands to general controller 40 and the internal command MACT to internal processing controller 62.

When internal processing controller 62 may receive the MACT command, it may issue internal row and column addresses to the row address buffer RAddBuf and column address buffer CAddBuf, respectively, of the bank 11 whose bank number was provided with the MACT command. At the same time, controller 62 may activate the column address burst element 66 of the relevant bank 11 to repeatedly activate the column for a long burst of reads or writes.

For reading data, the mirror main sense amplifier MMSA of the relevant bank 11 may receive the output and may provide it, via internal buffer IntBuf to internal bus 50, which, in turn, may provide the data to the relevant compute engine CE. Internal bus controller 64 may indicate to internal bus 50 where within compute engine CE to write the data. Compute engine CE may then process the data, as desired.

Once the computation has finished, the opposite operation may occur. Bus controller 64 may indicate to internal bus 50 which data to provide to mirror main sense amplifier MMSA, via internal buffer IntBuf. Mirror main sense amplifier MMSA may then write the data when column address burst element 66 may be active.

Internal processing controller 62 may issue an automatic pre-charge instruction to general controller 40 at the end of the MACT command. Internal processing controller 62 may also control the operations of mirror main sense amplifier MMSA and internal buffer IntBuf.

It will be appreciated that, in accordance with a preferred embodiment of the present invention, host processor 14 may issue time slots to internal processor 12 to operate. Internal processor 12 may utilize the time slots to perform whatever operation it currently requires on the currently active bank, for the next X cycles, such as 32 cycles, returning the bank to a pre-charged state, ready for host processor 14 to access it. Internal processor 12 may receive instructions for the current operation in any suitable manner.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A memory device comprising:
at least two memory banks storing data, said at least two memory banks being accessible by a host processor; and
an internal processor to receive a timeslot from said host processor and to process a portion of said data from an indicated one of said at least two banks of said memory array during said timeslot,
the remaining said banks being available to said host processor during said timeslot.

2. The memory device according to claim 1 and wherein said internal processor comprises an internal activator to activate said portion independent of activation of said remaining banks by said host processor during said timeslot.

3. The memory device according to claim 2 and wherein said internal activator comprises:
an internal processing controller to provide an internal address to column and row address buffers of said memory device upon receipt of said timeslot command; and
a column address burst element to provide address bursts to activated columns of said memory bank for the duration of said timeslot.

4. The memory device according to claim 1 and also comprising a command decoder to provide a timeslot command to said internal processor and to provide other commands to a general controller of said memory device.

5. The memory device according to claim 1 and wherein said memory array is a DRAM array.

6. A method of operating a memory device having banks storing data, the method comprising:
a host processor issuing per bank timeslots to an internal processor of a memory device;
said internal processor operating on an indicated bank of said memory device during said timeslot; and
said host processor not accessing said indicated bank during said timeslot.

7. The method according to claim 6 and wherein said operating comprises:
activating a row in an indicated bank of said memory device during a timeslot provided by said host processor;
transferring data from said row to an internal processor; and
precharging said row.

8. A method of operating a memory device, the method comprising:
a host processor issuing input and output commands to memory banks of said memory device; and
said host processor issuing a start processing command to an internal processor connected to said memory banks to start operating on an indicated one of said memory banks, said indicated bank not receiving either of said input and output commands for the duration of said start processing command.
